(19) United States
(12) Patent Application Publication
(10) Pub. No.: US 2002/0092717 A1
(43) Pub. Date: Jul. 18, 2002

(54) Flexible hydraulic brake line assembly for motor vehicle wheels

(75) Inventor: Merle T. Brumfield, Tipp City, OH (US)

Correspondence Address: JACOX, MECKSTROTH & JENKINS, 2310 Far Hills Building, Dayton, OH, 45419-1575, US

(73) Assignee: Harco Industries, Inc.

(21) Appl. No.: 09/760,355

(22) Filed: Jan. 12, 2001

(51) Int. Cl. B60T 11/00

(52) U.S. Cl. 188/152

(57) ABSTRACT

Hydraulic fluid is supplied to hydraulic brake cylinders for calipers and brake shoes of a motor vehicle through brake line assemblies each including a flexible multi-layer high pressure brake hose having opposite end portions each receiving a forged or inwardly swaged end portion of a small diameter high pressure steel tube. A metal collar receives each tube and is locked on the tube by a spring retaining washer or a forged stop rib on the tube and is crimped onto the end portion of the hose to form a direct tube-to-hose connection having high tensile strength. The opposite end portion of each metal tube is flared and receives an externally threaded tubular flare nut. The flare nut on one tube is threaded directly into a brake caliper, and the flare nut on the other tube is threaded into a brake control valve.

### BACKGROUND OF THE INVENTION

In the production of hydraulic brake line assemblies used on motor vehicles such as automobiles, it is common to use a multi-layer high pressure flexible hose of the type disclosed in U.S. Pat. No. 5,445,191. As generally illustrated in this patent, the hose includes an inner rubber tube, an outer rubber tube and an intermediate rubber tube with the inner rubber tube and the intermediate rubber tube each surrounded by braided reinforcing fibers. Such a flexible hose is commonly used in combination with bendable high pressure steel pipe or tubes having an outside diameter of about 3/16″ and an inside diameter of about ⅛″. Various types of special brass fittings are used to connect the flexible hose to the steel tubing and to connect the flexible hose to a caliper for a disk brake or to a hydraulic cylinder for a drum and shoe brake.

When a flexible high-pressure hose is connected to a brake caliper, it is common to use a fitting having a “banjo” head portion, for example, of the type disclosed in U.S. Pat. No. 4,626,006. Such a fitting is usually machined or fabricated from solid brass and includes a crimping collar or sleeve surrounding an end portion of the brake hose and a smaller concentric tubular nipple or eyelet which projects into the end portion of the tube. The brass eyelet has axially spaced circumferential ridges which grip the hose when the collar or sleeve is crimped inwardly against the end portion of the hose. The eyelet is sometimes formed as an integral part of the brass fitting, as shown in the '006 patent, or the eyelet may be a separate brass tube which is pressed into the collar or fitting and then brazed. The “banjo” head portion disclosed in the '006 patent comprises a block or eye-joint portion which has a cross bore for receiving a steel screw having internal fluid passages and threaded into the body of the caliper. The screw also extends through a pair of copper washers positioned on opposite sides of the fitting for forming high pressure seals between the fitting and the caliper. Frequently, the fitting has an internally threaded female fitting portion which is machined from brass along with the collar and eyelet.

A brass fitting with a collar and an integral or pressed-in nipple or eyelet and with a “banjo” head portion, such as disclosed in the '006 patent, is an expensive component for connecting the flexible brake hose to a brake caliper or cylinder, and adds significantly to the costs of the brake line assembly. When a bendable steel or brass tube is used to connect “banjo” head portion to a flexible rubber hose, one end portion of the tube is brazed to the head portion, and the opposite end portion of the tube is brazed to a brass fitting which has a collar and an internal eyelet that is also brazed to the fitting or machined as an integral part of the collar. Thus the various fittings which are used to connect the opposite end portions of a high pressure hose to a bendable steel tube and to a hydraulic cylinder within a brake caliper or for brake shoes usually require a brazing operation followed by a plating operation which add significantly to the cost of the brake line assembly and result in additional possible leak paths for the hydraulic fluid. In addition, many of the brass fittings commonly used are internally threaded or female fittings which are more difficult to produce in high volume with precision internal surfaces. U.S. Pat. No. 4,813,517 discloses a modular manifold brake hose end fitting for reducing the number of fittings in a vehicle brake line system.

### SUMMARY OF THE INVENTION

The present invention is directed to an improved and simplified flexible brake line assembly which provides significant features and advantages. For example, a brake line assembly of the invention significantly reduces the cost of an assembly by eliminating expensive brass fittings, eliminating brazing and plating operations, eliminating female threaded fittings and “banjo”-type fittings and simplifies the installation of the brake line assembly onto a motor vehicle. In addition, the brake line assembly of the invention minimizes potential leak paths, provides for convenient and rapid testing for high pressure leaks prior to shipment to a motor vehicle assembly plant, permits all of the brake line assemblies for a motor vehicle to be tied together to simplify handling, and further provides for installation of the assemblies to wheel brake calipers and other wheel brake cylinders and valves and manifolds with only one torque wrench.

In accordance with a preferred embodiment of the invention, a hydraulic brake line assembly includes a section of high pressure flexible hose with concentric rubber-like tubes having surrounding or braided reinforcing fibers and with opposite end portions of the hose each receiving an inwardly forged and reduced end portion of a high pressure bendable steel tube. The end portion of each steel tube is forged or deformed to provide the axial cross sectional configuration and an outer diameter similar to a tubular nipple or eyelet. A metal sleeve or collar surrounds each end portion of the hose and the corresponding forged end portion of the steel tube and has a hole or bore for receiving the steel tube. An outwardly projecting circumferential rib on the end portion of the tube or a spring steel retaining washer on the tube locks the collar onto the tube. The collar is crimped onto the end portion of the hose and cooperates with the rib or retaining washer to form a connection between the tube and the hose having a substantial tensile strength over 400 pounds.

The opposite end portion of the metal tube extending from each end portion of the flexible hose is formed with an outwardly projecting flare and receives an externally threaded or male flare nut. The flare nut may be threaded directly into a threaded port of a brake caliper or brake cylinder housing or valve body, and the port has a conical end surface for engaging the flared end of the metal tube. The metal tubes are bent to a predetermined configuration.

Other features and advantages of the invention will be apparent from the following description, the accompanying drawings and the appended claims.

### BRIEF DESCRIPTION OF THE DRAWINGS

FIG. 1 is a diagrammatic view of a hydraulic brake system for a motor vehicle or automobile and incorporating a brake line assembly constructed in accordance with the present invention for each of the wheel brakes;

FIG. 2 is a side elevational view of a brake line assembly constructed in accordance with the invention and with portions broken away to show that the length and curvature of each component may vary;

FIG. 3 is an enlarged fragmentary axial section taken generally on the line 3-3 of FIG. 2;

FIG. 4 is a fragmentary axial section illustrating the coupling of the brake line assembly to a brake caliper;

FIG. 5 is an enlarged fragmentary section of a deformed or forged end portion of a high pressure steel tube;

FIG. 6 is a fragmentary axial section of a die system or tooling for forging or reducing the end portion of a steel tube and before the end portion is reduced;

FIG. 7 is a section similar to FIG. 6 and illustrating the position of the die system after the end portion of the tube is reduced;

FIG. 8 is an end view of a typical die set shown in FIGS. 6 & 7;

FIG. 9 is an exploded perspective view of the die set shown in FIG. 8; and

FIG. 10 is an enlarged fragmentary section similar to FIG. 3 and showing a modification in accordance with the invention.

### DESCRIPTION OF THE PREFERRED EMBODIMENT

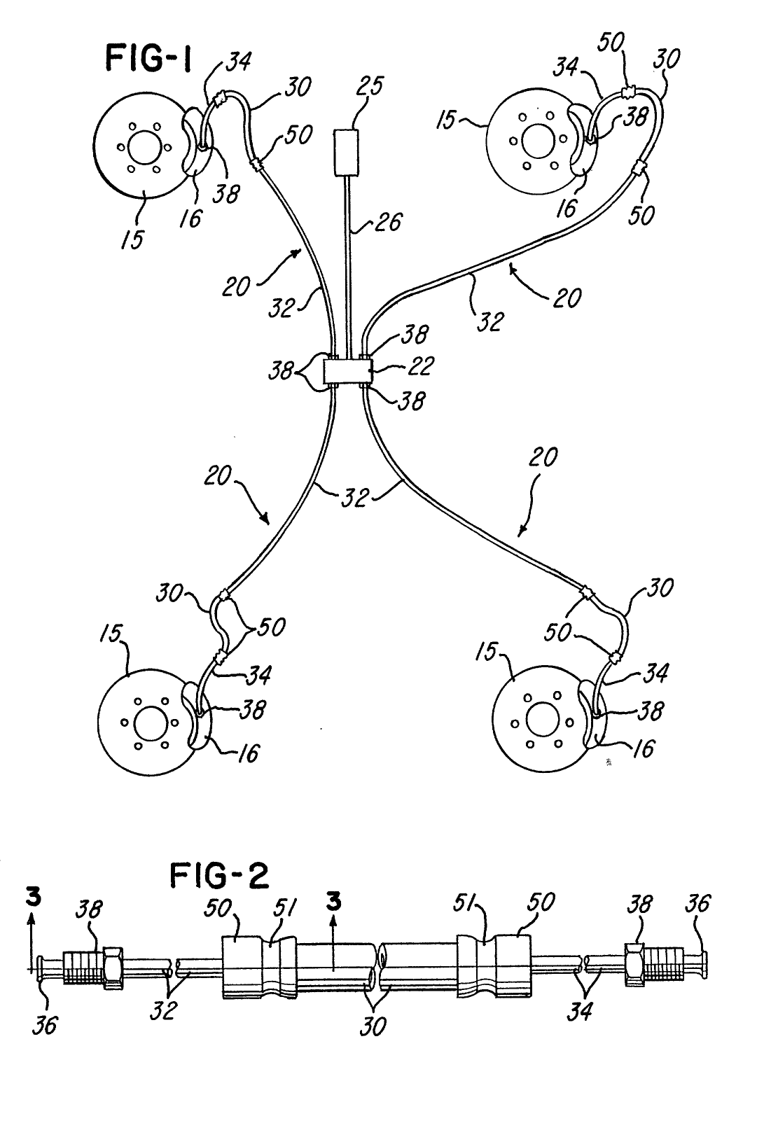

FIG. 1 illustrates a motor vehicle or automotive brake system including a brake disk 15 and a hydraulically actuated brake caliper 16 for each of the four wheels of the automobile. However, it is to be understood that any of the wheels may have a drum brake with brake shoes and a hydraulic cylinder or actuator (not shown) in place of a brake disk 15 and a caliper with a hydraulic cylinder or actuator 16. High pressure hydraulic fluid is supplied to each of the actuators or calipers 16 through a hydraulic brake line assembly 20 constructed in accordance with the invention. Each of the assemblies 20 extends from an automatic brake system (ABS) control valve 22 (FIG. 1) which is supplied with hydraulic fluid from a master brake cylinder 25 connected to the valve 22 by a high pressure steel tube or line 26.

In accordance with the present invention, each of the brake line assemblies 20 includes a high pressure flexible brake hose 30 which is constructed, for example, as disclosed in above mentioned U.S. Pat. No. 5,445,191, the disclosure of which is incorporated by reference. A high pressure and bendable steel tube 32 connects one end portion of each flexible hose 30 to the control valve 22, and a high pressure bendable steel tube 34 connects the opposite end portion of each flexible hose 30 to the corresponding brake actuator or caliper 16. Each of the bendable steel tubes 32 and 34 has a conventional outside diameter of 3/16″ and an inside diameter of ⅛″ and may be formed from stainless steel seamless tubing. The outer end portion of each tube 32 and 34 has an outwardly projecting flared end 36 and receives an externally threaded or male flare nut 38.

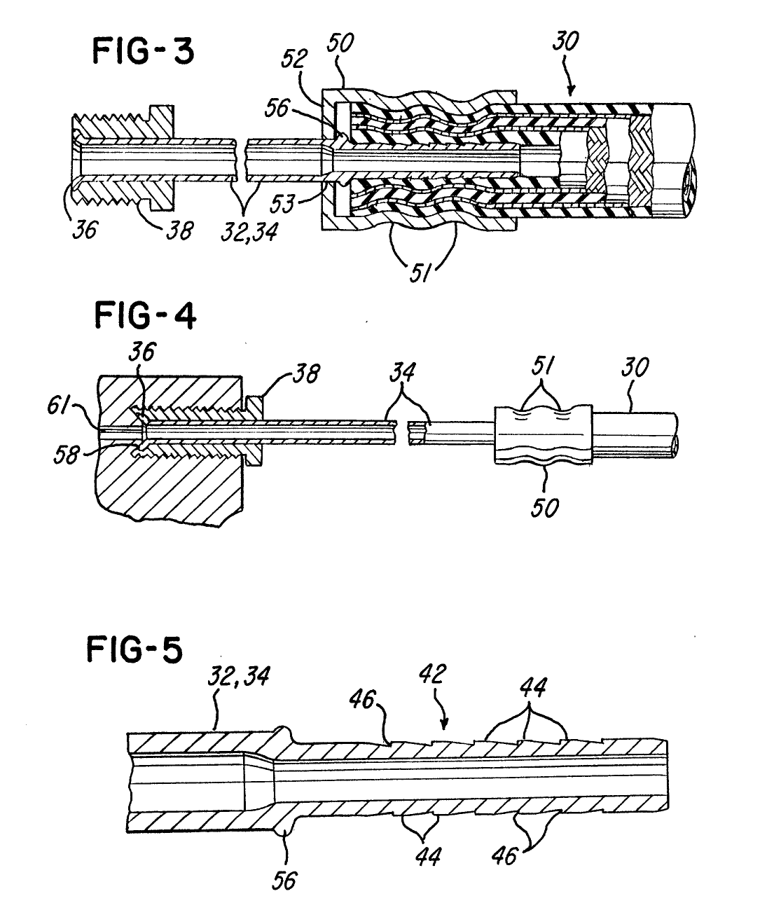

Referring to FIGS. 3 & 5, the inner or opposite end portion of each metal tube 32 and 34 has a mechanically deformed or forged end portion 42 (FIG. 5) which is forged or swaged radially inwardly to provide the end portion with an outside diameter of about 0.133″ and an inside diameter of about 0.063″. The tube end portion 42 is also provided with a series of axially spaced cylindrical lands or ridges 44 each of which extends from a sharp radial shoulder 46 to provide the end portion 42 with an axial cross sectional configuration similar to a conventional eyelet which is machined as an integral part of a conventional brass fitting or is pressed into a brass fitting and brazed, as mentioned above. The forged or reduced end portion 42 of each steel tube 32 and 34 slides snugly into an end portion of the high pressure hose 30, an the end portion of the hose is clamped to the end portion 42 of the metal tube 32 or 34 by an annular brass or stainless steel sleeve or collar 50. The collar 50 surrounds the end portion of the hose and is squeezed inwardly by either a single crimp 51 (FIG. 2) or a dual crimp 51 (FIGS. 3 & 4) or other crimps performed by a conventional crimping machine.

The collar 50 has an end portion or wall 52 with a center bore or hole 53 slightly larger than the outer diameter of the steel tubes 32 and 34 so that the collar 50 slides onto the tube during assembly. As shown in FIGS. 3 & 5, the end portion 42 of each tube 32 and 34 is formed or forged with an outwardly projecting circumferential rib 56 which is engaged by the end wall 52 of the collar 50. The rib 56 also engages and forms a stop for the adjacent end surface of the flexible hose 30. Thus after the metal collar 50 is crimped radially inwardly to compress the end portion of the hose against the ribbed end portion 42 of the steel tube, the end wall 52 of the collar 50 and the adjacent rib 56 cooperate to provide the connection with a substantial tensile strength, for example, over 400 pounds. The end wall 52 also protects the adjacent end of the tube.

Referring to FIG. 4, the opposite end portion of each metal tube 34 having a flared end 36, is coupled or secured to the housing or body of the corresponding caliper 16 by the corresponding externally threaded flare nut 38 which is threaded into an internally threaded port within the caliper body. Preferably, the caliper body port is machined with a tapered or conical seat 58 which surrounds a hydraulic fluid passage 61 within the caliper body and receives the flared end 36 of the tube 32 to form a high pressure fluid-tight seal when the flare nut 38 is tightened. The opposite end of each metal tube 32 is secured to the ABS brake control valve 22 by the corresponding externally threaded flare nut 38 and an internally threaded bore with a seat 58.

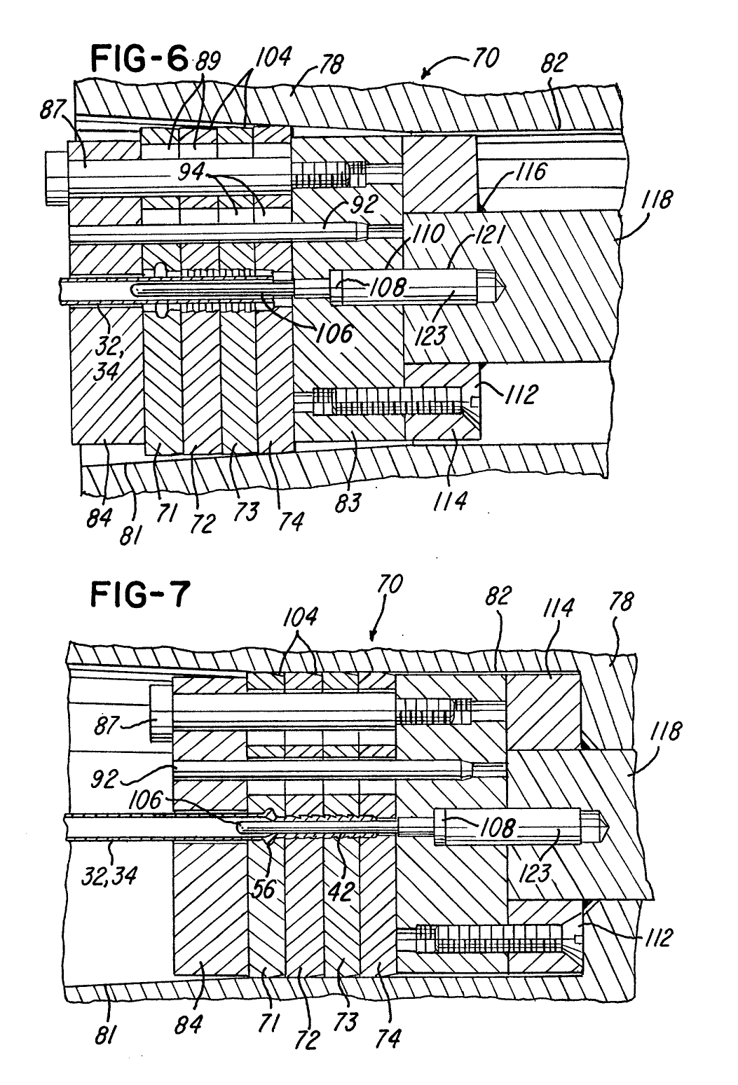

Referring to FIGS. 6-9, the deformed or forged end portion 42 on each of the steel tubes 32 and 34 is produced by forming or forging tooling 70 which includes a series of circular die sets 71, 72, 73 & 74 confined within a surrounding housing 78 having a tapered or part conical cam surface 81 extending from a cylindrical surface 82. The stack of die sets 71-74 are confined between a set of axially spaced cylindrical plates 83 and 84 which are tied together by a set of four shouldered screws 87. The screws 87 extend through corresponding aligned slots 89 within the die sets 71-74 and provide for radial sliding movement of the die sets. A set of axially extending guide pins 92 also connect the plates 83 and 84 and extend through corresponding slots 94 within the die sets.

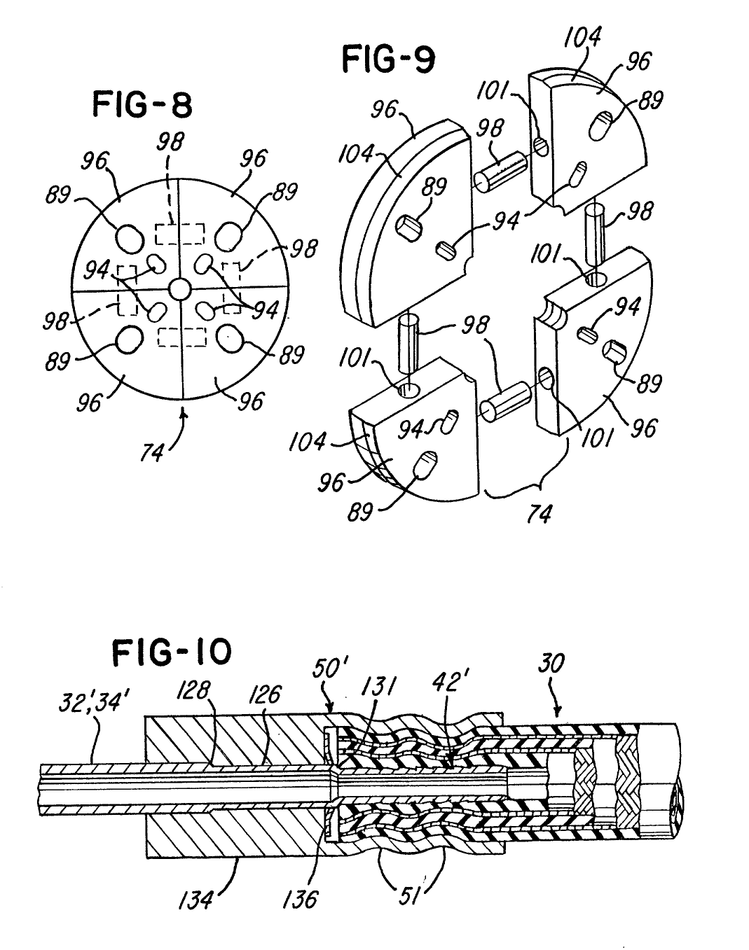

As shown in FIGS. 8 & 9, each of the die sets 71-74 includes four ¼ circular segments such as the four segments 96 for the die set 74. The 1/4 segments of each die set are held in alignment by a set of guide pins 98 which slide within corresponding holes or bores 101 within the die segments so that the die segments may move radially between retracted positions (FIG. 6) and inward forging positions (FIG. 7). As shown in FIGS. 6 and 7, each of the die sets 71-74 has center bore surfaces which together correspond to the outer contour of the deformed or forged end portion 42 of the steel tubes 32 and 34 and include recesses or cavities which form the ridges 44 and shoulders 46 as well as the circumferential rib 56.

Each of the die sets 71-74 has a peripheral tapered surface 104 which has the same slight taper as the tapered surface 81 within the housing or body 78. The plate 83 supports an axially extending center pin or mandrel 106 which has a diameter corresponding to the desired inside diameter of the forged end portion 42 of each of the tubes 32 and 34, for example, a diameter of 0.063″. The mandrel 106 has a cylindrical head portion 108 which is supported within a bore 110 formed within the center of the die plate 83. A set of four screws 112 (FIG. 6) secure the cylindrical die plate 83 to an annular plate 114 which is secured by a circumferential weld 116 to a piston rod 118 extending from a double acting hydraulic cylinder (not shown). The rod 118 has a center bore 121 which aligns with the bore 110 within the die plate 83 and confines a pin 123 for retaining the mandrel 106 within the die plate 83, as shown in FIGS. 6 and 7.

In operation of the forging or forming tooling 70, the piston rod 118 is extended within the housing 78 to the position shown in FIG. 6 where the sections 96 of the die sets 71-74 are retracted radially outwardly by springs (not shown) for freely receiving an end portion of a metal tube 32 or 34 which slides onto the mandrel 106. When the piston rod 118 and die sets 71-74 and steel tube are retracted by the hydraulic cylinder to the position shown in FIG. 7, the sections 96 of the die sets 71-74 are cammed radially inwardly by the cam surface 81 so that the die sets deform or forge the inner and outer configuration of the end portion 42 including the axially spaced ridges 44, the radial shoulders 46 and the stop rib 56. When the piston rod 118 is extended again, the segments 96 of the die sets 71-74 retract radially outwardly so that the end portion 42 of the tube may be withdrawn from the mandrel 106 and the die sets of the tooling 70. It is to be understood that the forging tooling shown in FIGS. 6-9 represents one form of tooling for quickly producing the forged end portions 42 on the steel pipes or tubes 32 and 34. However, the deformed or forged end portion 42 may also be formed by other means such as a roll-forming operation similar to the tooling used for roll-forming threads onto a bolt.

FIG. 10 shows a modification of a brake line assembly similar to that described above in connection with FIG. 3 and wherein the same components have the same reference numbers, and the modified components are identified with a prime mark or a new reference number. Each of the metal or steel tubes 32′ and 34′ have a forged or reduced end portion 42′ which extends from a forged or reduced cylindrical neck portion 126 having an outside diameter slightly less than the outside diameter of the tube 32′ or 34′ and slightly greater than the outside diameter of the end portion 42′ to form annular tapered shoulders 128 and 131. A metal or brass collar 50′ includes one or more crimps 51′ on the hose 30 and also includes an end portion 134 having a stepped center bore which slidably receives the tube and the neck portion 126. The collar portion 134 engages the shoulder 128 to form a stop for the tube when the end portion 42′ and neck portion 126 are inserted into the collar 50′. After the end portion 42′ and neck portion 126 are inserted into the center bore of the collar 50′ and before the collar 50′ receives the corresponding end portion of the hose 30, an annular spring steel retaining washer 136 is pressed onto the neck portion 126 of the tube 32′ or 34′ so that the collar 50′ is secured or locked onto the tube. The end portion of the hose 30 is then inserted into the collar 50′, and the collar 50′ is crimped with one or two crimp portions 51′ or other forms of crimps.

From the drawings and the above description, it is apparent that a hydraulic brake line assembly constructed in accordance with the present invention, provides desirable features and advantages. For example, one important feature is provided by the simplicity of a brake line assembly of the invention which eliminates expensive brass fittings, such as a fitting with a machined “banjo” block having an integral or pressed in eyelet, eliminates brazing of the fittings and thereby eliminates any plating operations required after brazing. The brake line assembly of the invention also permits the use of seamless stainless steel bendable tubing to form the tubes 32 and 34 or 32′ and 34′, which is sometimes highly desirable to eliminate or minimize corrosion.

The brake line assembly of the invention further substantially reduces the equipment for producing a brake line assembly and permits the use of one torque wrench for tightening all of the externally threaded flare nuts 38 into the brake calipers or brake cylinders as well as into a supply component such as the ABS brake control valve 22. Moreover, the brake line assemblies 20 minimize the paths for possible leaks and may be easily checked or tested with high pressure fluid or vacuum prior to shipment. The brake line assemblies 20, with the tubes 32 and 34 or 32′ and 34′ preformed on a CNC programmable tube bender, and for use on one automobile or vehicle, may also be assembled or tied together to facilitate shipment and for rapid and convenient handling and installation onto a vehicle on an assembly line. As a result of the above advantages, the brake line assembly of the invention provides a substantial total cost savings over the conventional brake line assemblies commonly installed on motor vehicles.

While the method and forms of brake line assembly and the forging tooling herein described constitute preferred embodiments of the invention, it is to be understood that the invention is not limited to the precise method, tooling and assemblies described, and that changes may be made therein without departing from the scope and spirit of the invention as defined in the appended claims.

What is claimed is:

1. A flexible hydraulic brake line assembly for use on a motor vehicle, comprising an elongated multi-layer high pressure flexible brake hose having a predetermined inside diameter, an elongated bendable metal tube having a predetermined outer diameter greater than said inside diameter of said hose, said metal tube having an inwardly forged and reduced integral end portion with outwardly projecting ridges and a diameter generally the same as said inside diameter of said hose, said integral and reduced end portion of said metal tube extending into an end portion of said hose, and a crimped annular metal collar surrounding said end portion of said hose and said integral and reduced end portion of said tube and positively compressing said end portion of said hose against said end portion of said tube.

2. An assembly as defined in claim 1 wherein said metal tube has an opposite end portion with an outwardly projecting flare, and an externally threaded tubular flare nut surrounding said opposite end portion of said tube.

3. An assembly as defined in claim 2 in combination with a hydraulic brake actuator having an internally threaded hole receiving said flare nut and connected to a hydraulic fluid passage within said actuator, and said actuator has a surface surrounding said passage and engaging said flare on said opposite end portion of said tube.

4. An assembly as defined in claim 1 wherein said collar includes an end portion having a hole with a diameter generally the same as said outer diameter of said metal tube, and said end portion of said collar is locked onto said tube to prevent removal of said tube from said collar and to provide said assembly with high tensile strength.

5. An assembly as defined in claim 4 wherein said integral end portion of said tube has a neck portion having an outer diameter smaller than said outer diameter of said tube, and said end portion of said collar closely surrounds said tube including said neck portion of said tube to increase the strength of said assembly.

6. An assembly as defined in claim 1 wherein said outwardly projecting ridges on said integral said end portion of said tube comprise a plurality of axially spaced peripherally extending ridges each having a sharp edge.

7. An assembly as defined in claim 6 wherein each of said ridges on said integral end portion of said tube comprise a substantially cylindrical surface extending from a substantially radial annular shoulder to form said sharp edge.

8. An assembly as defined in claim 1 and including an annular spring retaining washer gripping said tube and retaining said collar on said tube.

9. A flexible hydraulic brake line assembly for use on a motor vehicle, comprising an elongated multi-layer high pressure flexible brake hose having a predetermined inside diameter and opposite end portions, a set of elongated bendable metal tubes each having a predetermined outer diameter greater than said inside diameter of said hose, each of said metal tubes having an inwardly forged and reduced integral end portion with outwardly projecting ridges and having a diameter generally the same as said predetermined inside diameter of said hose, each said end portion of each said metal tube extending into a corresponding said end portion of said hose, and a crimped annular metal collar surrounding each of the corresponding said end portions of said hose and the corresponding said integral and reduced end portion of said tube and positively compressing the corresponding said end portion of said hose against said end portion of the corresponding said tube.

10. An assembly as defined in claim 9 wherein each of said metal tubes has an opposite end portion with an outwardly projecting flare, and an externally threaded tubular flare nut surrounding said opposite end portion of each said tube.

11. An assembly as defined in claim 10 in combination with a hydraulic brake actuator having an internally threaded hole receiving one of said flare nuts and connected to a hydraulic fluid passage within said actuator, and said actuator has a surface at the end of said hole and surrounding said passage and engaging said flare on said opposite end portion of one of said tubes.

12. An assembly as defined in claim 9 wherein each of said collars includes an end portion having a hole receiving the corresponding said tube, and said hole has a diameter generally the same as said outer diameter of said metal tube for protecting an adjacent end surface of said hose.

13. An assembly as defined in claim 12 wherein said integral end portion of each of said tube has a circumferentially extending rib having a diameter larger than said diameter of said hole within said end portion of the corresponding said collar and located between said end portion and an adjacent end surface of said hose to provide said assembly with high tensile strength.

14. An assembly as defined in claim 12 and including an annular spring retaining ring secured to each said tube within the corresponding said collar to prevent removal of said tube from said collar.

15. An assembly as defined in claim 9 wherein each of said ridges on said reduced integral end portions of said tubes comprise a generally cylindrical surface extending from a substantially radial annular shoulder.

16. A flexible hydraulic brake line assembly for use on a motor vehicle, comprising an elongated multi-layer high pressure flexible brake hose having a predetermined inner diameter, an elongated bendable metal tube having a predetermined outer diameter greater than said inner diameter of said hose, said metal tube having an inwardly forged and reduced integral end portion having an outer diameter generally the same as said predetermined inner diameter of said hose, said reduced integral end portion of said metal tube extending into an end portion of said hose, a crimped annular metal collar surrounding said end portion of said hose and said reduced integral end portion of said tube and positively compressing said end portion of said hose against said end portion of said tube, said collar including an end portion having a hole with a diameter generally the same as said outer diameter of said metal tube, and a stop preventing removal of said end portion of said tube from said end portion of said collar to provide said assembly with high tensile strength.

17. An assembly as defined in claim 16 wherein said metal tube has an opposite end portion with an outwardly projecting flare, and an externally threaded tubular flare nut surrounding said opposite end portion of said tube.

18. An assembly as defined in claim 17 in combination with a hydraulic brake actuator having an internally threaded hole receiving said flare nut and connected to a hydraulic fluid passage within said actuator, and said actuator has a hole end surface surrounding said passage and engaging said flare on said opposite end portion of said tube.

19. An assembly as defined in claim 16 wherein said flexible hose has an opposite end portion, and said opposite end portion of said hose receives a corresponding said reduced integral end portion of a second said metal tube and a corresponding said metal collar.

20. A method of making a flexible hydraulic brake line assembly for use on a motor vehicle, comprising the steps of forming an elongated flexible brake hose capable of withstanding high pressure hydraulic brake fluid and having a predetermined inside diameter, forming an elongated bendable metal tube having a predetermined outer diameter greater than the inside diameter of said hose, forging a reduced integral end portion on the tube to form outwardly projecting ridges and an outer diameter generally the same as said predetermined inside diameter of the hose, mounting an annular collar on said tube and connecting the collar to the tube to restrict removal of the tube from the collar, inserting the reduced integral end portion of the tube into an end portion of the hose, and crimping the annular collar against the end portion of the hose and the integral end portion of the tube for positively securing the end portion of the hose to the integral end portion of the tube.

21. A method as defined in claim 20 and including the step of flaring an opposite end portion of the tube to form an outwardly projecting flare, and positioning an externally threaded tubular flare nut around the opposite end portion of the tube.

22. A method as defined in claim 21 and including the step of forming a hydraulic brake actuator with an internally threaded hole receiving the flare nut and connected to a hydraulic fluid passage within the actuator, and forming a surface around the passage at the end of the hole to engage the flare on the opposite end portion of the tube.

23. A method as defined in claim 20 wherein the step of connecting the collar to the tube includes forming the collar with an end portion having a hole with a diameter generally the same as the outer diameter of the tube, forging a circumferentially extending rib on the tube with a diameter larger than the diameter of the hole within the end portion of the collar, and locating the rib between the end portion of the collar and an adjacent end surface of the hose.

24. A method as defined in claim 20 wherein the step of connecting the collar to the tube includes forming the collar with an end portion having a hole with a diameter generally the same as the outer diameter of the tube, and mounting a spring retaining washer on the tube between the reduced integral end portion of the tube and the end portion of the collar.
